(19) United States
(12) Patent Application Publication
(10) Pub. No.: US 2015/0101977 A1
(43) Pub. Date: Apr. 16, 2015

(54) PERFORATED LINE SERVICE PASTA BASKET

(71) Applicant: LOUIS S. GERMANO, FLORHAM PARK, NJ (US)

(72) Inventor: LOUIS S. GERMANO, FLORHAM PARK, NJ (US)

(21) Appl. No.: 14/052,565

(22) Filed: Oct. 11, 2013

(51) Int. Cl. A47J 19/00

(52) U.S. Cl. CPC A47J 19/005
USPC 210/470; 210/497.01

(57) ABSTRACT

The perforated line service pasta basket is fabricated from single-ply food service grade stainless steel. A steel sheet is heat-compressed into a cylindrical shape and provided with a single-ply perforated bottom wall. The bottom wall is raised to stimulate water circulation within the basket. A handle is provided on the basket to allow for manipulation of the basket to and from a pasta cooker. The use of stainless steel eliminates the possibility of rusting, thereby decreasing the chance of foodborne illness caused by contamination.

### BACKGROUND OF THE INVENTION

1. Field of the Invention

The present invention generally relates to cooking appliances, and particularly to a perforated line service pasta basket for use with a commercial pasta cooker.

2. Description of the Related Art

Pasta is usually prepared commercially by placing the pasta in a perforated receptacle(s) and submerging the receptacle in boiling water contained in a pasta cooker. When done, the receptacle is removed from the pasta cooker, and the water is allowed to drain from the pasta. Heretofore, the pasta-containing receptacle(s) has been fabricated from wire mesh material. The use of wire mesh material has caused continuous problems due to rusting. The iron ore components in the welds in the wire mesh construction eventually break down. Rust from the material passes into the water and is absorbed in the pasta, thereby contaminating the pasta. When ingested by the consumer, the contaminated pasta can cause gastrointestinal discomfort that may range from mild to serious. The food industry would certainly welcome a pasta basket that could efficiently cook pasta and avoid the dangers of food contamination due to rust. Thus, a perforated line service pasta basket solving the aforementioned problems is desired.

### SUMMARY OF THE INVENTION

The perforated line service pasta basket is fabricated from food service grade single ply stainless steel. A steel sheet is heat-compressed into a cylindrical shape and provided with a single-ply, perforated bottom wall. The bottom wall is raised to stimulate water circulation beneath the basket. A handle is provided on the basket to allow for manipulation of the basket to and from a container of boiling water. The use of stainless steel eliminates the possibility of rusting, thereby decreasing the chance of foodborne illness caused by contamination.

Accordingly, the invention presents an improved cooking appliance that is substantially rust-proof. Although designed to cook pasta in a commercial kitchen, the appliance is an excellent tool for blanching or steaming vegetables and thawing frozen foods. Usable with gas pasta cooker machines as well as stock pots, the appliance minimizes water waste and maximizes the ability of the food service operator to efficiently perform line cooking tasks. The invention provides improved elements and arrangements thereof for the purposes described which are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of perforated line service pasta baskets according to the present invention, shown being used in a commercial pasta cooker.

FIG. 2 is a rear view of the perforated line service pasta basket of FIG. 1.

FIG. 3 is a bottom view of the perforated line service pasta basket of FIG. 1.

Similar reference characters denote corresponding features consistently throughout the attached drawings.

### DETAILED DESCRIPTION OF THE PREFERRED EMBODIMENTS

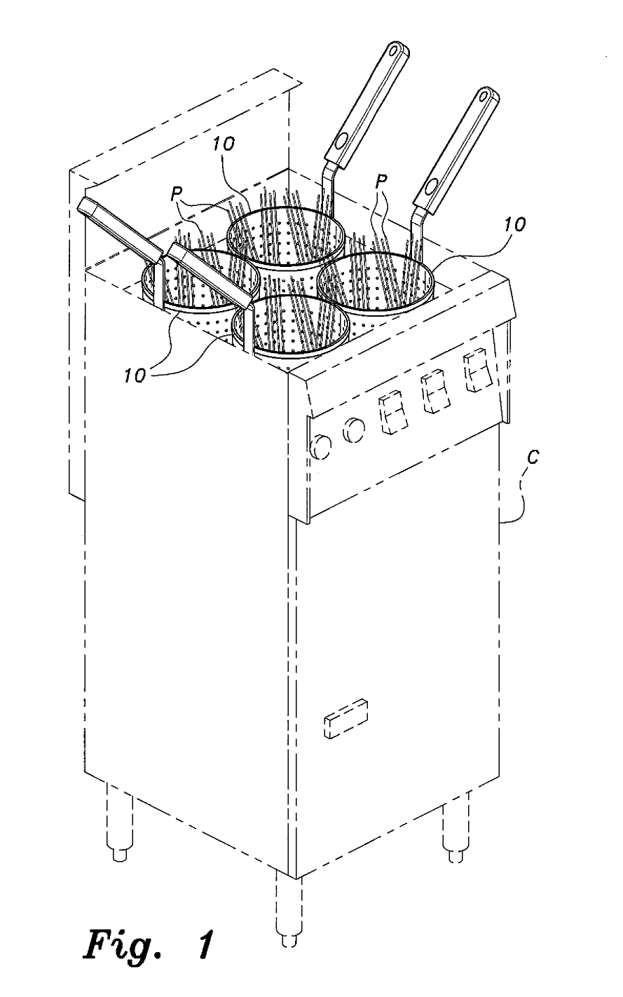

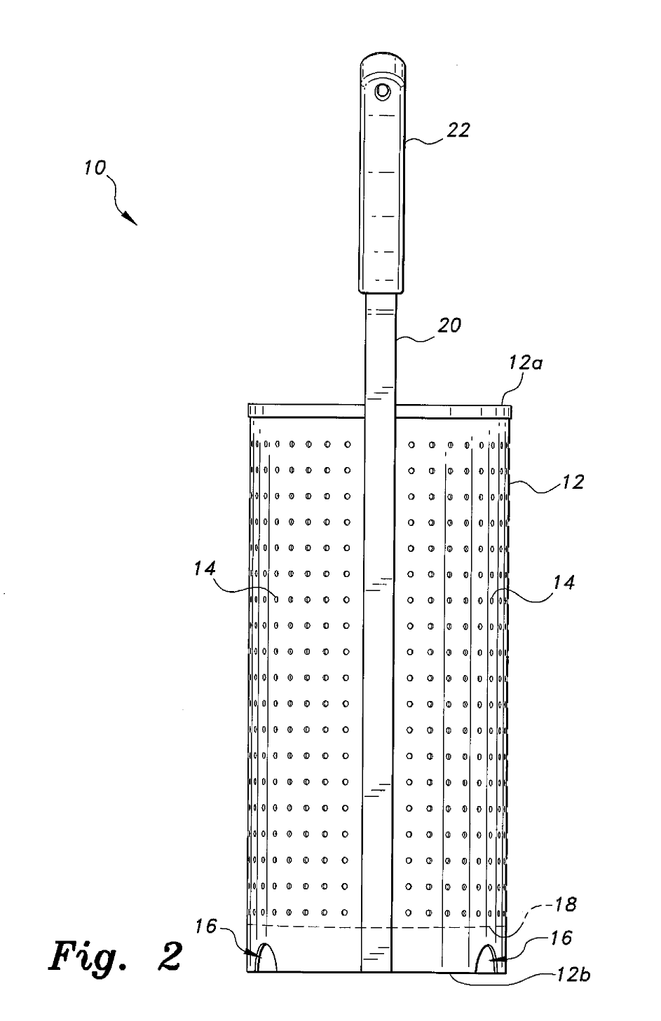

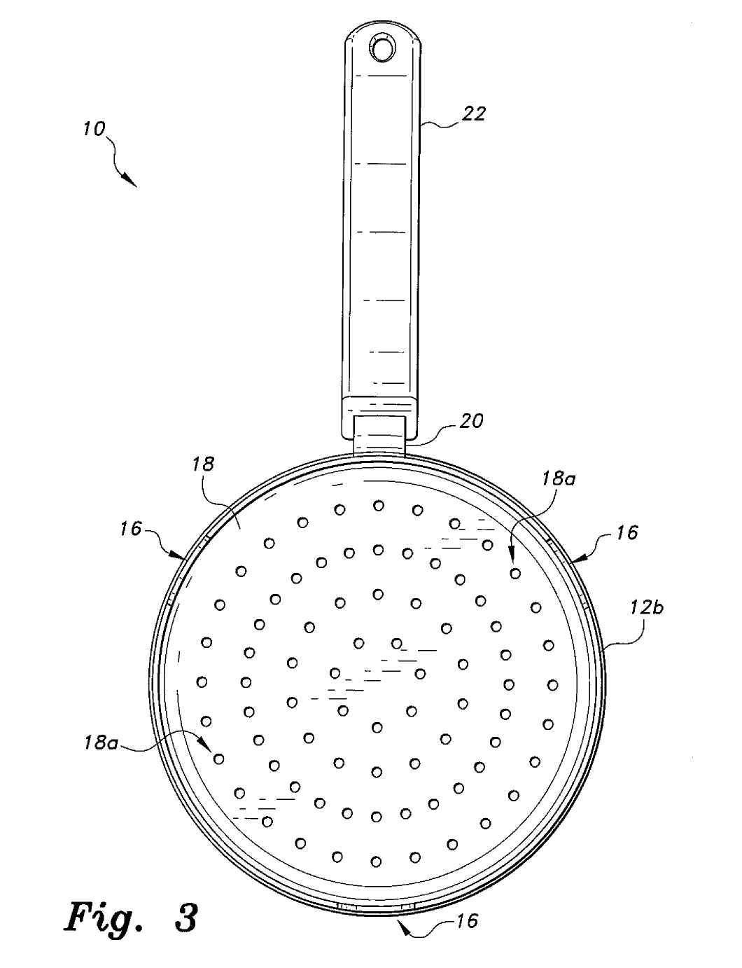

Referring to FIGS. 1-3, the perforated line service pasta basket is generally indicated at 10. The basket 10 comprises a cylindrically configured wall 12 having respective upper end 12a and lower edge 12b. Although a cylindrical configuration is preferred in order to reduce bacteria that collect in the corners of polygonal baskets, it should be noted that other configurations (rectangular, hexagonal, etc.) may be suitable. A plurality of perforations 14 is disposed over substantially the entire area of the wall 12. At least three openings 16 are evenly spaced around the periphery of the lower edge 12b for reasons explained below. A bottom wall 18 having perforations 18a therein is heat welded adjacent the lower edge 12b and is raised a distance vertically above the lower edge or rim of the cylinder. The perforations 14,18a are greater than ⅛ of an inch in diameter to maximize drainage. A handle 20 is positioned at the rear of the basket 10. The handle 20 is constructed with a 140° angle relative to the wall 12 at its upper end to allow the foodservice operator to avoid heat from the boiling water when lifting a basket 10 from a conventional commercial pasta cooker C. An ergonomically designed plastic gripping member 22 is disposed on the upper end of the handle 20 to provide ease when gripping the handle 20, and to facilitate control when lifting the basket 10. As noted above, the basket 10 is cast from a single-ply food service grade stainless steel. The handle 20 is also fabricated from food service grade stainless steel. The basket 10 and handle 20 may be electropolished for improved corrosion resistance. The basket 10 will have a height of approximately 9 inches and a diameter of approximately 6.5 inches. These dimensions will allow a plurality of baskets 10 to be effectively accommodated in the commercial pasta cooker C.

In use, the basket 10, filled with pasta P, is immersed in a pasta cooker C of boiling water. The boiling water circulates through the basket 10 via perforations 14, 18a and openings 16. When the pasta P is cooked, the basket 10 is lifted from the cooker C, and water is drained from the pasta P through the basket 10 via the perforations 14, 18a. The openings 16 in the lower edge 12b prevent water from collecting beneath the bottom wall 18, reducing the risk of bacterial contamination.

It is to be understood that the present invention is not limited to the embodiments described above, but encompasses any and all embodiments within the scope of the following claims.

I claim:

1. A perforated line service pasta basket for use with a commercial pasta cooker, comprising:
at least one rust-resistant sidewall defining a tubular basket, the basket having an open upper end and a lower end, the at least one wall having a lower edge; and
a bottom wall extending across the lower end of the tubular basket, the bottom wall being elevated vertically above the lower edge, the at least one sidewall and the bottom wall having a plurality of perforations defined therein for draining water from the basket, the lower end of the at least one wall having a plurality of openings formed therein between the bottom wall and the lower edge to prevent water draining through the bottom wall from collecting beneath the bottom wall.

2. The perforated line service pasta basket according to claim 1, further including a handle disposed on said at least one sidewall, said handle extending at an angle above the open upper end of the tubular basket.

3. The perforated line service pasta basket according to claim 2, further including a plastic, ergonomically designed gripping member disposed on said handle.

4. The perforated line service pasta basket according to claim 1, wherein the perforations are each greater than ⅛ of an inch in diameter.

5. The perforated line service pasta basket according to claim 1, wherein said at least one sidewall and said bottom wall are each fabricated from single-ply sheets of food service grade stainless steel.

6. A perforated line service pasta basket for use with a commercial pasta cooker, comprising:
at least one rust-resistant sidewall defining a tubular basket, the basket having an open upper end and a lower end, the at least one wall having a lower edge;
a bottom wall extending across the lower end of the tubular basket, the bottom wall being elevated vertically above the lower edge, the at least one sidewall and the bottom wall having a plurality of perforations defined therein for draining water from the basket;
a handle disposed on the at least one sidewall, the handle extending at an angle above the open upper end of the tubular basket; and
a plastic, ergonomically designed gripping member disposed on the handle.

7. The perforated line service pasta basket according to claim 6, wherein said handle extends at an angle of 140° to said at least one sidewall.

8. The perforated line service pasta basket according to claim 6, wherein the lower end of the at least one wall has a plurality of openings formed therein between the bottom wall and the lower edge to prevent water draining through the bottom wall from collecting beneath the bottom wall.

9. The perforated line service pasta basket according to claim 6, wherein said perforations are each greater than ⅛ of an inch in diameter and wherein the basket has a height of approximately 9 inches and a diameter of approximately 6.5 inches.

10. The perforated line service pasta basket according to claim 6, wherein said at least one sidewall and said bottom wall are each fabricated from single-ply sheets of food service grade stainless steel.

11. A perforated line service pasta basket, comprising:
at least one rust-resistant sidewall defining a tubular basket, the basket having an open upper end and a lower end, the at least one wall having a lower edge;
a bottom wall extending across the lower end of the tubular basket, the bottom wall being elevated vertically above the lower edge, the at least one sidewall and the bottom wall having a plurality of perforations defined therein for draining water from the basket, the perforations each being greater than ⅛ of an inch in diameter, the lower end of the at least s one wall having a plurality of openings formed therein between the bottom wall and the lower edge to prevent water draining through the bottom wall from collecting beneath the bottom wall;
a handle fabricated from stainless steel disposed on the at least one side, said handle extending at an angle above the open upper end;
a plastic, ergonomically designed gripping member disposed on said handle; and
a commercial pasta cooker for receiving said pasta basket therein.

12. The perforated line service pasta basket according to claim 11, wherein said handle extends at an angle of 140° to said at least one sidewall and wherein the basket has a height of approximately 9 inches and a diameter of approximately 6.5 inches.

13. The perforated line service pasta basket according to claim 12, wherein said at least one sidewall and said bottom wall are each fabricated from single-ply sheets of food service grade stainless steel.
